(19) United States
(12) Patent Application Publication
(10) Pub. No.: US 2006/0091699 A1
(43) Pub. Date: May 4, 2006

(54) Bulkhead for a motor vehicle

(76) Inventors: Marco Braun, Lug (DE); Steve Kober, Treuen OT Schreiersgrun (DE)

Correspondence Address: KAPLAN GILMAN GIBSON & DERNIER L.L.P., 900 ROUTE 9 NORTH, WOODBRIDGE, NJ, 07095, US

(21) Appl. No.: 10/529,295

(22) PCT Filed: Oct. 2, 2003
(86) PCT No.: PCT/EP03/10954

§ 371 Date: Sep. 14, 2005

(30) Foreign Application Priority Data
Oct. 2, 2002 (DE) 102 46 998.9

(51) Int. Cl. B62D 29/00

(52) U.S. Cl. 296/181.2

(57) ABSTRACT

An end wall for a motor vehicle may include: a first wall as well as a second wall distanced thereto, a foam arranged between the first and second wall, an allocated first opening arranged in the first wall, an allocated second opening in the second wall for leading through a through-body penetrating the openings, wherein the foam at least in regions bears on the through-body, a peripheral gap is arranged between the through-body as well as the first and/or second wall in the region of the allocated openings, the foam comprises a foam opening for leading through the through-body, the foam opening—when the through-body has not been introduced, at least in regions—has a smaller diameter than the through-body.

### BACKGROUND

The present invention relates to an end wall (also known as “front wall” or as “bulk head”) for a motor vehicle.

An end wall for a motor vehicle is known in principle. With this, it is the case of a separating wall between the motor space and the vehicle passenger space. The end wall fulfils various tasks. On the one hand its serves for the stability of the car body (e.g. against torsion about the longitudinal axis of the vehicle), on the other hand it serves e.g. for crash safety (against penetration of components from the motor space into the vehicle interior with a frontal collision). Furthermore it serves for the thermal as well as sound insulation between the motor space and vehicle interior.

End walls may have a “sandwich construction”. Here, the end wall comprises a first wall as well as a second wall distanced to this, and foam is arranged between the first and second wall.

But often there exists the necessity to create connections from the motor space to the motor vehicle interior and for this to provide openings in the end wall. These may e.g. be openings for leading through a longitudinal rod or for leading through supply ducts of the air conditioning installation, etc.

For this, the end wall usually comprises openings which e.g. are provided with a radial rubber seal. The rubber seal at the same time has the task of sealing a through-body led through openings of the end wall, in the region of the first and second wall, in that the rubber seal suitably bears on the through-body. At least the transfer of airborne sound as well as the entry of moisture from the motor space into the vehicle interior may be prevented by way of this.

The disadvantage with this however is the fact that the adaptation and assembly of this rubber seal is quite costintensive. Added to this is the fact that the rubber seal only offers a limited tolerance compensation so that on the one hand it is possible that with a rubber seal which is too tight, a damage to the rubber seal on leading through the through-body occurs. On the other hand it is quite possible that if the rubber seal is selected too large, a residual gap remains, and by way of this the entry of moisture or the transfer of airborne sound into the vehicle interior becomes possible.

It is therefore the object of the present invention to create an end wall which on the one hand may be manufactured in an economical manner and on the other and prevents the passage of moisture or sound from the motor space to the vehicle interior to an as large extent as possible.

### SUMMARY OF THE INVENTION

This object is achieved by an end wall according to claim 1.

This specifies an end wall for a motor vehicle, wherein the end wall comprises a first wall as well as a second wall distanced to this, and a foam is arranged between the first and the second wall. An allocated first opening is arranged in the first wall, and an allocated second opening is arranged in the second wall, for leading through a through-body which penetrates the openings. The foam at least in regions bears on the through-body. A peripheral gap is arranged in the region of the allocated openings, between the through-body as well as the first and/or second wall. This gap may either be an air gap or may be filled with foam. It is important however that no direct contact is given between the first or the second wall and the through-body.

Such an end wall has the advantage that a direct contact between the through-body and the first or second wall is prevented and thus a structure-borne sound transfer from the through-body to the first or second wall (which thus represent the outer walls of the “sandwich”) is avoided. The foam which reaches up to the through-body at the same time prevents the passage of airborne sound from the motor space into the vehicle interior. Furthermore a barrier against the passage of moisture is rendered possible by way of the foam.

At the same time it is particularly advantageous that no additional sealing elements such as radial rubber seals need to be used for sealing. The assembly effort is reduced by way of this. The foam which is present in any case in the sandwich serves for sealing. This foam thus apart from having a sound-insulating or stabilising effect additionally has the effect that it carries the through-body or insulates the penetration location with regard to sound and moisture.

Here several variants for manufacturing the end wall are possible. On the one hand it is possible for the through-body itself to be “foamed-in” on manufacture of the end wall. Depending on the nature of the foam or the surface of the through-body (this may be coated e.g. with Teflon), there then results a firm connection between the foam and the through-body, or also no firm connection. In a further variant it is possible for the through-body of not being in its final position on foaming out the sandwich construction. Here e.g. it is possible by way of a suitable moulding tool or by way of the provision of a sleeve (to be removed later) to create a foam opening for a through-body to be introduced later.

Advantageous designs of the present invention are specified in the dependent claims.

One advantageous design envisages the foam to be polyurethane foam. This has the advantage that a foaming which fills the inner space is particularly simply possible. It is of course possible to attach premanufactured foam sections in the intermediate space between first and second wall.

A further advantageous design envisages the first and/or second wall being of metal or plastic and having a wall thickness between 0.6 mm and 6 mm. Here the modulus of elasticity of the material should be as high as possible. What is decisive is the modulus of elasticity of the complete composite of walls and foam lying therebetween. However here the weight of the design must also be taken into account.

One particularly advantageous design envisages the foam being profiled in the contact region to the through-body. Here the foam e.g. with regard to its profile may have a wave structure which only contacts the through-body in regions. By way of this an even simpler introduction of the through-body is possible since the friction resistance is smaller on introduction. Despite this, in the region of the “wave hills”, thus in the contact region between the foam and the through-body one may achieve a particularly high pressing pressure which thus may reliably prevent a transfer of airborne sound. For manufacturing such a wave structure it is e.g. possible to use a mandrel on foaming with polyurethane, which is e.g. coated with Teflon and may be removed again from the foam after the foaming process.

A further advantageous design envisages the foam in the region at least of one opening, e.g. the first opening, to terminate essentially flush with the allocated wall (thus the first wall) on the side which is distant to the opposite wall (thus the second wall). I.e. that the end wall at its outer sides terminates with the foam in a practically flat manner. Of course it is also possible for the foam to be set back inwards with respect to the outer sides of the end wall so that an air gap remains between the through-body and the first or second opening in the region of the first or second opening.

Furthermore one advantageous design envisages the foam in the region of the opening, e.g. the first opening, to project beyond the allocated wall (thus the first wall) to the side which is distant from the opposite wall. This in practise means that the foam projects laterally out of the sandwich structure of the end wall. An even better support effect for penetration bodies which are led through is achieved by way of this. Furthermore, the transmission of structure-borne sound from the through-body directly to the first or second wall is prevented in an even more secure manner. Furthermore an even better airborne sound insulation is possible by way of the longer foam lengths along the through-body. An even better tolerance compensation is particularly advantageous since the flexible foam along the complete length of the through-body may bear on this and thus a transfer of airborne sound is prevented in an even more secure manner.

One further advantageous design envisages the through-body e.g. to be round and a diameter between. With this it may be the case e.g. of a steering rod etc. rotatable relative to the foam. It is however also possible for it to be the case of an aluminium tube which for transmitting fluids (e.g. for the air conditioning installation) extends from the motor space to the motor vehicle interior.

A further design envisages the through-body to be designed as a sleeve for leading through rods, cables or likewise. It is indeed advantageous for the through-body to be formed itself e.g. by way a tube conduit and to have direct contact with the foam. The variant of the through-body as a sleeve for leading through rods etc. however is possible for cases in which a relative movement e.g. of a rod to the foam which would otherwise be too large is given.

A further advantageous further formation envisages the gap between the through-body and the wall in the region of the allocated opening to be between 5 mm and 20 mm. By way of this it is ensured that even with a vibrating end wall, a structure-borne sound transmission by way of contacting the through-body as well as the first or second wall is prevented.

A further advantageous design envisages one wall, e.g. the first wall, in the region of the allocated first opening to be inwardly curved to the side which is distant to the respective opposite wall (thus here the second wall). This in practise means that a vaulting of the end wall to the outside is given. By way of this, in particular with an oblique passage of the through-body through the sandwich, an even longer carrying (support) length of the through-body in the foam is rendered possible. Apart from an improved stability, here an even better acoustic damping and a correspondingly good tolerance compensation are ensured.

A further advantageous design envisages one wall, i.e. the first wall, if this represents the wall on the motor space side, to comprise an additional sealing lip in the region of the associated first opening for embracing the through-body. An effective spray protection may be ensured by way of this. Multiple seals are also possible.

A further particularly advantageous design envisages the foam to comprises a foam opening for leading through the through-body, wherein the foam opening, when the through-body has not been introduced, at least in regions has a smaller diameter than the through-body. By way of this one succeeds in achieving an even better sound-insulation as well as moisture sealing effect by way of the pressing pressure of the foam on the through-body. For a simplified assembly one may envisage the foam opening being narrowed in the course of the assembly direction of the through-body, so that an even simpler assembly is achieved (with a low as possible damage to the foam).

Further advantageous designs of the present invention are specified in the remaining dependent claims.

### BRIEF DESCRIPTION OF THE DRAWING

The invention is now explained by way of several Figures. There are shown in:

FIG. 1 a first cut-out of an end wall according to the invention, with a through-body arranged therein,

FIG. 2 a second cut-out of the end wall according to the invention, with a further through-body arranged therein.

### DETAILED DESCRIPTION OF THE INVENTION

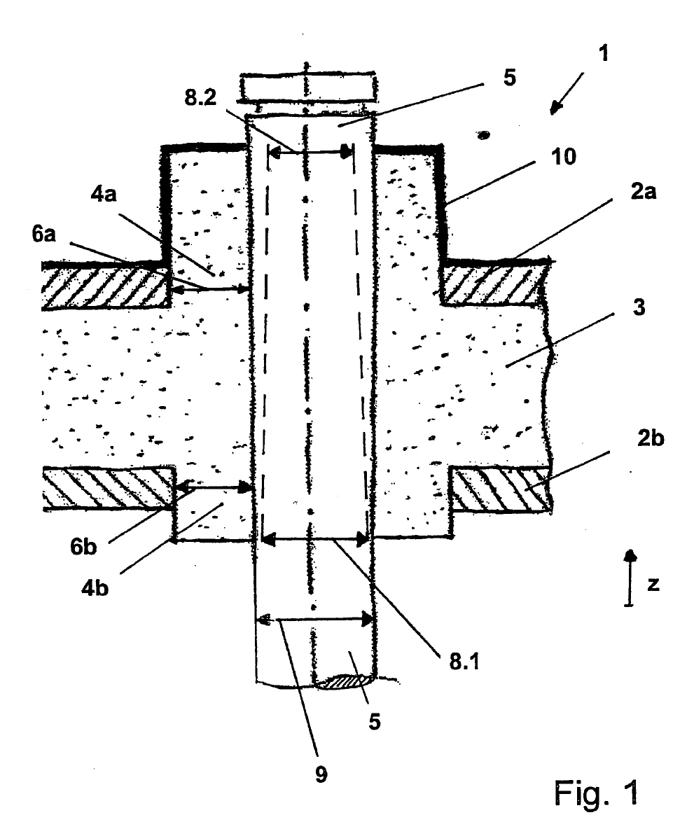

FIG. 1 shows an end wall 1 for a motor vehicle. The end wall comprises a first wall 2a as well as a second wall 2b distanced to this. Foam 3 is arranged between the first and second wall. The first wall 2a comprises an allocated first opening 4a and the second wall 2b comprises an allocated second opening 4b. A through-body 5 penetrates the first opening 4a as well as the opening 4b which is flush with this. The foam 3 at the same time bears on the through-body 5, it embraces it cylindrically in FIG. 1.

A gap 6a filled with foam is arranged between the through-body 5 as well as the first opening 4a.

In the region of the second opening 4b between the through-body 5 as well as the second wall there is provided a peripheral gap 6b filled with foam, which is likewise filled out with foam.

The foam is of polyurethane; the first wall 2a as well as the second wall 2b are in each case of plastic. The introductory description is referred to with regard to details of geometry and material.

The gap 6a and 6b have an extension of 4 mm to 35 mm, 5 mm to 20 mm are also possible (see dimension arrows in FIG. 1).

The through-body 5 is an aluminium tube which represents a connection/evaporator/heat exchanger and thus e.g. transports condensation water of the air conditioning installation between the passenger space and the motor space. A round, oval, polygonal etc. cross-sectional shape is possible for all penetration bodies 5 according to this invention. On account of safety regulations it is necessary for this material to be constructed of such a stable material as aluminium. It is particularly here that the advantageous nature of the present invention comes in, since with a contact of the first wall 2a or second wall 2b with the through-body 5, a heavy transmission of structure-borne sound would occur. Therefore a corresponding transmission of structure-borne sound is minimised by the intermediate foam. Additionally, for reducing vibrations transmitted to the aluminium tube, a part of this aluminium tube is covered by way of a suitable plastic hose in the motor space.

A particularly good leading of the through-body 5 as well as a particularly secure protection of the structure-borne sound transmission from the through-body 5 to the first wall 2a or second wall 2b is achieved in that the foam on the outer sides of the end wall 1 project beyond the first and second wall in each case on the outer sides. An adequate guiding (lead) length of the foam to the through-body 5 is achieved by way of this, by which means on the one hand a good sealing effect is achieved and on the other hand a stable guiding is achieved.

The foam 3 has been foamed from polyurethane foam, the foam opening for leading through the through-body 5 here was kept free by way of a suitable Teflon-coated mandrel which was removed after the foaming [out] procedure.

For an improved illustration of the context, the (uniform) diameter 9 of the through-body 5 is shown in FIG. 1. The diameter of the foam opening is indicated with a dashed line. “Foam opening” is the opening in the foam caused by the mandrel, into which the through-body 5 was introduced in the direction z. Here the diameter of the foam opening is indicated in the entry side at 8.1. This diameter reduces in the assembly direction z to the measure 8.2. By way of the reduced dimension of the foam opening with respect to the diameter of the through-body 5, a firm bearing of the foam on the through-body and thus a good airborne sound insulation as well as moisture barrier is ensured.

On the upper side of the end wall shown in FIG. 1, a protective layer 10 is attached on the first wall 2a or the projecting part of the foam 3. Here it may e.g. be the case of an aluminium layer which is vapour deposited and which prevents an electrical charging of parts of the wall or of the through-body. Alternatively here a plastic film etc. may be attached for an even better sealing from the entry of fluid.

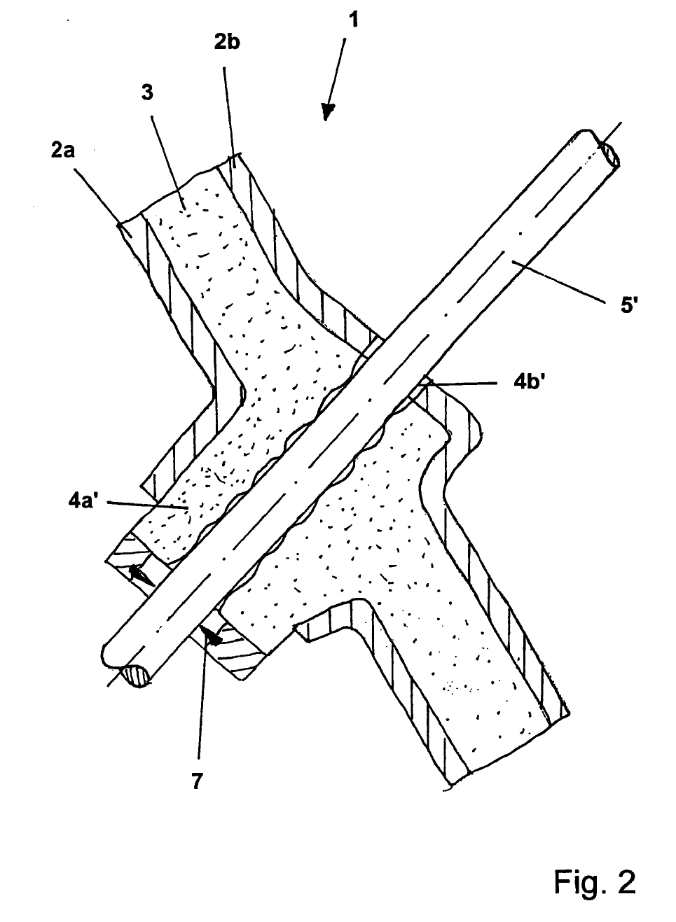

FIG. 2 shows another section of the end wall 1. All of the above-described features (of FIG. 1 as well as the introductory description) also apply to the description of FIG. 2 inasmuch as is not expressly stated otherwise. With the through-body shown in FIG. 2 it is the case of a steering rod 5′ which is rotatable about its longitudinal axis. The foam 3 which is arranged between the first wall 2a and the second wall 2a projects in the region of the first opening 4a′ beyond this opening. In the region of the second wall 2b the foam does not project into the opening 4b′ of the wall 2b, so that in the region of the opening 4b′ only an air gap between the through-body 5′ and the adjacent wall 2b is given.

The walls in FIG. 2 in each case are curved outwardly in the region of the first opening 4a′ as well as in the region of the second opening 4b′. By way of this a larger guide length of the foam 3 results for the through-body 5′.

In contrast to FIG. 1, the foam 3 in the contact region with the through-body 5′ is profiled in cross section. I.e. that along the longitudinal axis of the through-body 5′ the foam comprises constrictions at a distance. A contact of foam and through-body is given in the region of these constrictions. By way of this a simpler rotation of the through-body 5′ is achieved since one needs to overcome less frictional work. An additional sleeve with a rubber lip 7 which offer a spray protection from fluid is connected in front of the foam in the region of the first opening 4′.

The present invention thus describes an end wall for a motor vehicle, wherein the end wall comprises a first wall as well as a second wall distanced to this, and a foam is arranged between the first wall and the second wall, and an allocated first opening is arranged in the first wall and an allocated second opening in the second wall, for leading through a through-body, wherein the same foam which is arranged in a flat (large-surfaced) manner between the first and second wall, at least in regions, bears on the through-body, and a peripheral gap is arranged between the through-body as well as the first and/or second wall in the region of the allocated openings. The advantages according to the invention are in particular also achieved due to the fact that one and the same foam is used for the end wall insulation as well as for the contact of the through-body. With the end wall shown in the present invention it is not the case of a separate end wall insulation, but of a two-walled end wall in a sandwich construction which consists of two cover layers which are foamed to one another. The basic idea at the same time is the simultaneous foaming of a sealing collar so that no separate part (such as bloated foam insert) is necessary. Thus one requires no type of joining of such a separate sealing collar.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. An end wall for a motor vehicle, comprising:
a first wall having an allocated first opening arranged therein;
a second wall distanced from the first wall and having an allocated second opening therein;
a through-body extending through the first and second openings and defining peripheral gaps between the through body and the respective first and second openings;
foam arranged between the first and second walls, which foam bears on at least some regions of the through-body and is disposed in the peripheral gaps, and which foam comprises a foam opening for accommodating the through-body that has a smaller diameter than the through-body in at least some regions when the through-body is not present.

14. The end wall according to claim 13, wherein the foam is a polyurethane foam.

15. The end wall according to claim 13, wherein the first and/or second wall is formed of metal or plastic and has a wall thickness of between about 1 mm and about 30 mm.

16. The end wall according to claim 13, wherein the foam opening includes a profile in a region of contact with the through-body.

17. The end wall according to claim 13, wherein the foam in the region of at least one of the first and second openings terminates essentially flush with the first or second wall allocated therewith on a side distant to the opposite wall.

18. The end wall according claim 13, wherein the foam in the region of the first opening projects beyond the first wall to a side distant to the opposite second wall.

19. The end wall according to claim 13, wherein the through-body is one of substantially round, oval or polygonal, in cross section.

20. The end wall according to claim 13, wherein the through-body is designed as a sleeve for leading through rods, cables, wires or the like.

21. The end wall according to claim 13, wherein the peripheral gaps between the through-body and first and/or second walls in the region of the respective first and/or second openings is between about 4 mm and about 35 mm.

22. The end wall according to claim 13, wherein the first wall in the region of the allocated first opening is curved to the side which is distant to the respective opposite second wall.

23. The end wall according to claim 13, wherein at least one of the first and second walls in the region(s) of the respective associated first and second openings comprises an sealing lip.

24. The end wall according to claim 23, wherein the diameter of the foam opening tapers in a longitudinal direction of the through-body.
